(19) United States
(12) Patent Application Publication
(10) Pub. No.: US 2024/0141260 A1
(43) Pub. Date: May 2, 2024

(54) LIQUID DETERGENT COMPOSITION

(71) Applicant: RECKITT BENCKISER FINISH B.V., Hoofddorp (NL)

(72) Inventors: Alias Younis AL-BAYATI, Heidelberg (DE); Torsten ROTH, Heidelberg (DE); Boris SEITZ, Heidelberg (DE)

(21) Appl. No.: 18/548,344

(22) PCT Filed: Mar. 9, 2022
(86) PCT No.: PCT/EP2022/056095

§ 371 Date: Aug. 30, 2023

(30) Foreign Application Priority Data
Mar. 12, 2021 (GB) 2103434.3

(51) Int. Cl. C11D 3/39; C11D 3/16; C11D 3/34; C11D 17/04

(52) U.S. Cl. CPC C11D 3/392; C11D 3/168; C11D 3/3418; C11D 17/043; C11D 2111/40

(57) ABSTRACT

A liquid detergent composition comprising manganese 1,4,7-triazacyclononane (MnTACN) and derivatives thereof, a hydrotrope and a non-ionic surfactant, wherein the composition is contained in a water-soluble film; and wherein the hydrotope is selected from the group comprising salts of cumenesulphonate, xylenesulphonate and/or toluenesulphonate. Use of the composition in an automatic dishwashing process.

The present disclosure relates to automatic dishwashing compositions, and the method of manufacture and the use of the same.

Detergents, in particular automatic dishwashing products, that have a smooth, continuous visual appearance, such as transparent liquids, are typically more aesthetically appealing to consumers than aesthetically more heterogeneous compositions in granular, powder or tablet form. Liquids are also faster-dissolving in use. Multi-compartment water-soluble automatic dishwashing detergent pouches comprising one or more forms of detergent (e.g. solids, liquids and/or gels) are becoming more and more popular and are particularly attractive to consumers as they give the appearance of highly concentrated detergents with compartments each serving a different purpose.

In order to achieve a high level of cleaning and shine performance, automatic dishwashing products need to contain significant quantities of active ingredients such as builders, co-builders, surfactants, polymers, enzymes, bleaching compounds and sometimes anti-corrosion or glass-protecting agents. In a multi-compartment pouch that comprises a liquid compartment at least some of the actives need to be in the liquid phase to achieve the required performance of the multi-benefit product. Furthermore, a greater degree of separation of active components can be beneficial for the stability, compatibility and activity of the active ingredients.

It is also desirous for such a liquid formulation to be transparent in order to be both aesthetically pleasing and to convey purity and efficacy. Such a composition should also have the ability to be dyed in order to improve the appearance of both the composition and any wider detergent product that it may be incorporated into.

It is therefore desired to have a compartment as part of a water-soluble dishwashing multi-compartment pouch that contains a bleach catalyst(s) in a liquid composition. Such pouches are typically made from polyvinyl alcohol (PVOH). Such a composition would provide an enhanced bleaching performance due to increased availability and consistent dosing, as well as providing a compartment that has a specific function of boosting performance on bleachable stains.

The manganese 1,4,7-triazacyclononane complex (MnTACN) was originally designed as a model system for metallo-proteins and in 1994 the molecule was adopted as a bleach catalyst in laundry and automatic dishwashing formulations and enabled the low temperature removal of bleachable stains and starch residues as well as anti-tarnishing benefits. Despite this widespread use and countless academic studies, the stability of the complex in the presence of standard detergent ingredients is still a major challenge for formulators in the technical field.

Previous attempts to obtain a liquid, transparent composition comprising MnTACN suffered multiple drawbacks such as the solvent system causing in PVOH plasticisation/degradation over time and the decomposition of the MnTACN in storage.

There is therefore a technical need to develop a stable liquid formulation comprising the MnTACN to overcome current stability and aesthetic limitations that is compatible with PVOH. Furthermore, there are difficulties incorporating MnTACN in the wider formulation due to its inherent incompatibility with sodium percarbonate, surfactants (certain alkoxylated fatty alcohols) and certain solvents, which result in unappealing discolorations, precipitation and concomitant loss of bleach activity.

The present invention addresses the above technical problems. In a first aspect of the present invention there is provided a liquid detergent composition comprising manganese 1,4,7-triazacyclononane (MnTACN) and derivatives thereof, a hydrotrope and a surfactant, preferably a non-ionic surfactant, wherein the composition is contained in a water-soluble film.

It was surprisingly found that such compositions are able of dissolving the MnTACN bleach catalyst resulting in transparent liquids while remaining suitable for use with PVOH containers.

By derivatives of MnTACN, we hereby include all ligands that have a 1,4,7-triazacyclononane backbone, such as 1,4,7-trimethyl-1,4,7-triazacyclononane or the bridged ligand 1,2-bis(octahydro-4,7-dimethyl-1H-1,4,7-triazonine-1-yl)ethane (TMEM). All references to MnTACN herein are intended to refer to MnTACN and derivatives unless specified otherwise.

By hydrotrope, we mean compounds that solubilise hydrophobic compounds in aqueous solutions by means other than micellar solubilization.

Preferably, the composition further comprises an organic solvent, preferably dipropylene glycol. Advantageously, the organic solvent is present in an amount of from 50 to 90% by weight, such as from 60 to 80% by weight, or from 65 to 75% by weight.

Preferably water is present in an amount of from 1 to 20% by weight, such as from 1.5 to 15% by weight, from 2 to 12% by weight, from 1 to 10% by weight or even from 4 to 8% by weight.

Advantageously, the hydrotrope is present in an amount of from 0.1 to 20% by weight, such as from 0.5 to 15% by weight, from 0.7 to 10% by weight, or even from 0.9 to 7% by weight. The hydrotrope is selected from the group comprising salts of cumenesulphonate, xylenesulphonate and/or toluenesulphonate, such as the alkali, preferably sodium, salts.

Preferably the MnTACN is present in an amount from 0.2 to 5% by weight, such as from 0.4 to 4% by weight, from 0.5 to 3% by weight, or even 0.6 to 1.2% by weight.

Advantageously, the MnTACN is present in an amount of from 0.1 to 30 mg, such as from 0.1 to 20 mg or from 0.4 mg to 18 mg.

Preferably, the MnTACN is present in a concentration of from 0.1 to 30 mg/mL, such as from 1 to 25 mg/mL, preferably from 2 to 20 mg/mL, from 5 to 16 mg/mL, or even from 7 to 12 mg/mL.

Advantageously, the surfactant is present in an amount of from 5 to 45% by weight, such as from 6 to 40% by weight, from 8 to 35% by weight, from 12 to 30% by weight, or even from 15 to 25% by weight.

Advantageously, the composition further contains one or more of a dye and/or material care agent (such as glass, stainless steel, aluminium, silver or copper protection agent(s)) and/or other beneficial actives. The dye and/or material care agent may be present in an amount of from 0.5 to 20% by weight, such as from 1 to 15% by weight, or even from 1 to 10% by weight.

Preferred silver/copper protection agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is benzotriazole (BTA).

Without wishing to be bound by theory, it is believed that the addition of a nitrogen donor ligand, such as BTA, helps to stabilise the MnTACN against degradation in solution.

Preferably, the composition contains less than 1% by weight, such as from 0 to 0.9% by weight, or even 0% by weight, of bleaching agents (such as percarbonate), polyglycols, builders (such as methyl glycine diacetic acid), enzymes, and/or surfactants (such as alkoxylated fatty alcohols).

Preferably, the composition is transparent. The term transparent liquid means that it is possible to read Ariel size 5 text through the liquid with a 1 cm path length.

In an embodiment, the composition according to the invention is contained in a water-soluble film, preferably a polyvinyl alcohol (PVOH) film. The composition, excluding any water-soluble film, preferably weighs from 0.1 to 3 g, such as from 0.15 to 1 g, from 0.2 to 0.7 g, or even 0.2 to 0.65 g. Preferably, the product is in a unit dose or monodose form. In other words, the product preferably comprises the composition in combination with other compositions in the quantity required for a single wash cycle of a machine dishwasher. The terms monodose and unit dose may be used interchangeably throughout this disclosure. The composition is preferably contained within a multi-chamber monodose detergent.

Advantageously, the composition is stable in a water-soluble film. By the term ‘water-soluble’ or ‘water-dispersible’ container as used herein, it is meant a package which at least partially dissolves in water or disperses in water at 20° C. within 10 minutes to allow for egress of the contents of the package into the surrounding water.

By stable we mean that the composition can be stored for two weeks at 5° C. with no change in colour, precipitation, deflation of the compartment or visible plasticisation.

In a second aspect of the invention there is provided a method of making a composition according to the invention; wherein the method comprises the sequential addition of the hydrotrope, water, MnTACN, the organic solvent if present, and the surfactant.

In a third aspect of the invention, there is provided the use of a composition according to the invention in an automatic dishwashing process.

It is intended that all described features can be combined with one or more other features in any combination. All percentages are by weight unless otherwise specified. All references to ‘between’ and percentages are intended to include the stated end points and so are equivalent to ‘from’ and ‘to’.

The invention is described by the following non-limiting Examples

### EXAMPLES

The colour and stability of the MnTACN complex in selected solvents was reviewed and the results presented in Table 1.

TABLE 1

| | Formulations (weight %) | | |
|---|---|---|---|
| Ingredients | 1 | 2 | 3 |
| Water | 99.57 | — | — |
| Nonionic surfactant* | — | 89.57 | 89.29 |
| Sodium cumenesulphonate | — | 10.00 | 10.00 |
| (40% aq.) | | | |
| MnTACN | 0.43 | 0.43 | 0.60 |
| Red dye | — | — | 0.11 |

Results

| | | | |
|---|---|---|---|
| Initial visual observation | Clear dissolution | Clear dissolution | Clear dissolution |
| Visual evaluation after 8 days at | Slight | Discolouration | Discolouration |
| 50° C. in glass beaker | discolouration | | |
| Visual evaluation after 8 days at | Not compatible | Precipitate and | Precipitate and |
| 50° C. in PVOH | | colourless | colourless |
| | | crystals formed, | crystals formed, |
| | | liquid | liquid |
| | | separation, | separation, |
| | | PVOH stiff and | PVOH stiff and |
| | | hardened | hardened |

*fatty alcohol alkoxylate

The testing demonstrated that (1) the MnTACN fully dissolves in water, (2) low water levels are already sufficient to achieve dissolution, (3) sodium cumenesulphonate is a suitable hydrotrope to achieve a homogeneous surfactant containing solution phase and (4) fine tuning of the desired colour can be achieved via addition of a conventional red dye.

However, it was also shown that this approach is incompatible with the desired water-soluble films, resulting in plasticisation of the poly(vinyl alcohol). Moreover, storage in PVOH sachets results in clear signs of MnTACN degradation (i.e. discoloration and precipitation).

On this basis the formulation as set out in Table 2 was prepared and evaluated in storage stability trials, with the results shown in Table 3.

TABLE 2

| Ingredients | Formulation (%) | Order of addition |
|---|---|---|
| Water | 5.0 | 2 |
| Nonionic surfactant* | 19.1 | 5 |
| Sodium cumenesulphonate | 5.0 | 1 |
| (40% aq.) | | |
| MnTACN | 0.9 | 3 |
| Dipropylene glycol | 70.0 | 4 |

*fatty alcohol alkoxylate

TABLE 3

| Storage Conditions | Results after 6 weeks |
|---|---|
| 5° C./50% RH | No visual change |
| 30° C./70% RH | No visual change |
| 40° C./75% RH | Slight darkening of liquid, no |
| | precipitation or flocculation |
| | PVOH foil slightly wrinkled |
| 50° C./20% r.h. | No visual change |

In conclusion, a balanced composition comprising a surfactant, a hydrotrope and water has been developed in order to successfully solubilize the MnTACN complex and have suitable stability properties. Furthermore, dipropylene glycol has been identified a suitable inert bulk solvent.

The invention is defined by the claims:

1. A liquid detergent composition comprising:
manganese 1,4,7-triazacyclononane (MnTACN) and derivatives thereof;
a hydrotrope; and
a non-ionic surfactant,
wherein the liquid detergent composition is contained in a water-soluble film, and
wherein the hydrotope is selected from the group consisting of salts of cumenesulphonate, xylenesulphonate, and toluenesulphonate.

2. The liquid detergent composition according to claim 1, wherein the liquid detergent composition further comprises an organic solvent.

3. The liquid detergent composition according to claim 2, wherein the organic solvent is present in an amount of from 50 to 90% by weight.

4. The liquid detergent composition according to claim 1, wherein the liquid detergent composition further comprises water in an amount of from 1 to 20% by weight.

5. The liquid detergent composition according to claim 1, wherein the hydrotrope is present in an amount of from 0.1 to 20% by weight.

6. The liquid detergent composition according to claim 1, wherein the MnTACN is present in an amount from 0.2 to 5% by weight.

7. The liquid detergent composition according to claim 1, wherein the non-ionic surfactant is present in an amount of from 5 to 45% by weight.

8. The liquid detergent composition according to claim 1 further comprising a dye.

9. The liquid detergent composition according to claim 1, wherein the liquid detergent composition contains less than 1% by weight of percarbonate.

10. The liquid detergent composition according to claim 1, wherein the liquid detergent composition is transparent.

11. The liquid detergent composition according to claim 1, wherein the water-soluble film is a polyvinyl alcohol (PVOH) film.

12. The liquid detergent composition according to claim 11, wherein the liquid detergent composition weighs from 0.1 to 3 g.

13. The liquid detergent composition according to claim 11 or 12, wherein the liquid detergent composition is contained within a multi-chamber detergent pouch.

14. A method of making the liquid detergent composition according to claim 1, comprising:
sequentially adding the hydrotrope, the water, the MnTACN, the organic solvent if present, and the surfactant.

15. A method of using the liquid detergent composition according to claim 1 in an automatic dishwashing process, the method comprising:
adding the liquid detergent composition to a machine dishwasher.

16. The liquid detergent composition according to claim 2, wherein the organic solvent is dipropylene glycol.

17. The liquid detergent composition according to claim 12, wherein the liquid detergent composition weighs from 0.15 to 1 g.
